(19) United States
(12) Patent Application Publication
(10) Pub. No.: US 2020/0271083 A1
(43) Pub. Date: Aug. 27, 2020

(54) HEATING SYSTEM FOR ENGINE

(71) Applicant: Caterpillar Inc., Deerfield, IL (US)

(72) Inventors: Joseph Kennedy, Zionsville, IN (US); Lee Kress, Lafayette, IL (US)

(73) Assignee: Caterpillar Inc., Deerfield, IL (US)

(21) Appl. No.: 16/286,353

(22) Filed: Feb. 26, 2019

(51) Int. Cl. F02N 19/10

(52) U.S. Cl. CPC F02N 19/10; F01P 2060/18; F01P 2037/02

(57) ABSTRACT

A heating system for an engine includes a heater and a heat exchanger. The heater increases the temperature of an engine coolant and circulates the engine coolant into the heat exchanger. The heat exchanger is located with an oil pan. The heat exchanger received the heated engine coolant and transfers heat from the engine coolant into engine lubricant in the oil pan. The engine coolant flows from the heat exchanger into an engine block of the engine. The engine coolant transfers heat to the engine block and flows back to the heater to be heated again.

### TECHNICAL FIELD

The present disclosure generally pertains to an engine. More particularly this application is directed toward a jacket water and oil heating system for an engine.

### BACKGROUND

Low engine oil and jacket water temperature reduces start-ability of large diesel and spark ignition gas engines. Oil viscosity increases significantly at lower temperatures, which negatively impacts start-ability. Engine block temperature is directly impacted by internal jacket water coolant temperature. Engines in cold ambient locations require jacket water and/or engine oil heaters to achieve starting requirements. Currently, separate heating systems and methods have been used to heat jacket water coolant and engine oil, which can be costly and complex.

U.S. Pat. No. 8,042,609 to Farzad Samie describes an apparatus for improving the fuel economy of a vehicle. The apparatus includes a transmission having a transmission sump that contains transmission fluid, and a heat exchanger disposed within said sump and at least partially submerged in the transmission fluid. The apparatus also includes an engine having a plurality of engine coolant channels. An engine pump is operatively connected to the engine. The engine pump is configured to transfer engine coolant through the plurality of engine coolant channels and then through the heat exchanger. Heat from the engine coolant is transferred to the transmission fluid when the engine coolant passes through the heat exchanger. The heat transferred to the transmission fluid decreases transmission fluid viscosity such that transmission spin losses are reduced and fuel economy is improved.

The present disclosure is directed toward overcoming one or more of the problems discovered by the inventors.

### SUMMARY

A heating system for use with an engine having an oil pan and an engine block is disclosed herein. The engine block includes an engine block inlet and an engine block outlet The heating system includes a heater and a heat exchanger. The heater is disposed outside of the engine block and the oil pan and is in fluid communication with the engine block. The heater can include a heater inlet, and a heater outlet in fluid communication with the heater inlet. The heat exchanger is disposed within the oil pan and has a heat exchanger inlet and a heat exchanger outlet in fluid communication with the heat exchanger inlet. The heating system further includes a heater to heat exchanger fluid path that extends from the heater outlet into the oil pan and to the heat exchanger inlet, a heat exchanger to engine block fluid path extending from the heat exchanger outlet, through the oil pan, and to the engine block inlet, and an engine block to heater fluid path extending from the engine block outlet to the heater inlet.

The present disclosure is directed toward overcoming one or more of the problems discovered by the inventors.

### BRIEF DESCRIPTION OF THE FIGURES

The details of embodiments of the present disclosure, both as to their structure and operation, may be gleaned in part by study of the accompanying drawings, in which like reference numerals refer to like parts, and in which:

FIG. 1 is a block diagram of an exemplary engine heating system in FIG. 1;

FIG. 2 is a block diagram of another exemplary engine heating system;

FIG. 3 is a perspective view of an exemplary heater; and

FIG. 4 is a plan view of an exemplary heat exchanger.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent that those skilled in the art will be able to understand the disclosure without these specific details. In some instances, well-known structures and components are shown in simplified form for brevity of description. Some of the surfaces have been left out or exaggerated for clarity and ease of explanation

FIG.1 is a block diagram of an exemplary engine heating system. The engine heating system 100 includes a single tier oil pan 160 and an engine block 170 of an engine with the rest of the engine not shown, and a heating system 200. The single tier oil pan 160 may be configured so that it has a single tier or an even bottom. The heating system 200 includes a heater 210, a heater to heat exchanger fluid path 232, a heat exchanger 220, a heat exchanger to engine block fluid path 234, and an engine block to heater fluid path 236. The various fluid paths mentioned herein can comprise one or more tubes, hoses, or pipes or similar structures through which a liquid can be transported. The heating system 200 can provide an engine coolant circuit that circulates an engine coolant from the heater 210 through the oil pan 160, through the engine block 170, to the heater 210. The coolant circuit can include the heater 210, the heater to heat exchanger fluid path 232, the heat exchanger 220, the heat exchanger to engine block fluid path 234, the engine block 170, and the engine block to heater fluid path 236.

The heater 210 can be disposed outside of the engine block 170 and single tier oil pan 160 and may comprise a jacket water heater. The heater 210 can include a heater inlet 212 and a heater outlet 214. The heater to heat exchanger fluid path 232 is connected to the heater 210 via heater outlet 214 and is in fluid communication with the heater 210.

The heat exchanger 220 can include a heat exchanger inlet 222 and a heat exchanger outlet 224. The heater to heat exchanger fluid path 232 is connected to the heat exchanger inlet 222. In an example, the heater to heat exchanger fluid path 232 can extend through a first sealed port 162 on the single tier oil pan 160 to the heat exchanger inlet 222. The heat exchanger 220 is in fluid communication with the heater to heat exchanger fluid path 232. The heat exchanger 220 can be disposed within the single tier oil pan 160 below oil level. In an example the heat exchanger 220 is mounted to the single tier oil pan 160. The heat exchanger 220 can be disposed proximate to center of the oil pan 160.

The engine block 170 can include an engine block inlet 172 and an engine block outlet 174 to provide access to jacket water passages that can be cored out through and around the engine block 170. The engine block inlet 172 and engine block outlet 174 can be referred to as a jacket water passage inlet and a jacket water passage outlet respectively. The jacket water passages and jacket water passage inlet and outlet can be part of the engine coolant circuit. The engine block inlet 172 and engine block outlet 174 can be engine coolant ports such as jacket water ports. The heat exchanger to engine block fluid path 234 can connect to the heat exchanger outlet 224 and extend through the single tier oil pan 160 and through a second sealed port 164 on the single tier oil pan 160 to the engine block inlet 172. The heat exchanger to engine block fluid path 234 can be in fluid communication with the heat exchanger 220. The engine block 170 can be in fluid communication with the heat exchanger to engine block fluid path 234. The engine block to heater fluid path 236 can connect to the engine block outlet 174 and extend to the heater inlet 212 and be in fluid communication with the engine block 170. The heater to heat exchanger fluid path 232, the heat exchanger to engine block fluid path 234, and the engine block to heater fluid path 236 may comprise of silicon fluid paths, industrial hoses, conduit, piping, or other delivery systems of the like.

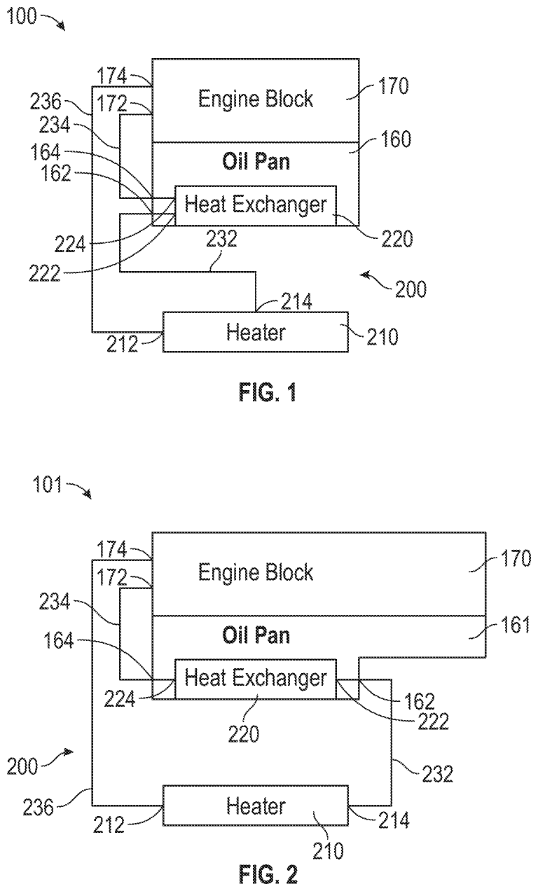

FIG. 2 is a block diagram of another exemplary engine heating system. An engine heating system 101 includes similar features to those described above in relevance with FIG. 1. The descriptions of the features shown in FIG. 1 can be applied again to the repeated referenced features shown in FIG. 2. The engine heating system 101 may have a multi-tier oil pan 161. As shown in FIG. 2, the multi-tier oil pan 161 can have a lower tier or a portion that is lower than the rest and an upper tier or a portion that is higher than the rest. For example the multi-tier oil pan 161 may be similarly shaped to the molded oil pans found on the market. In an example the heat exchanger 220 can be disposed at or near the lower tier or the lowest portion of the multi-tier oil pan 161.

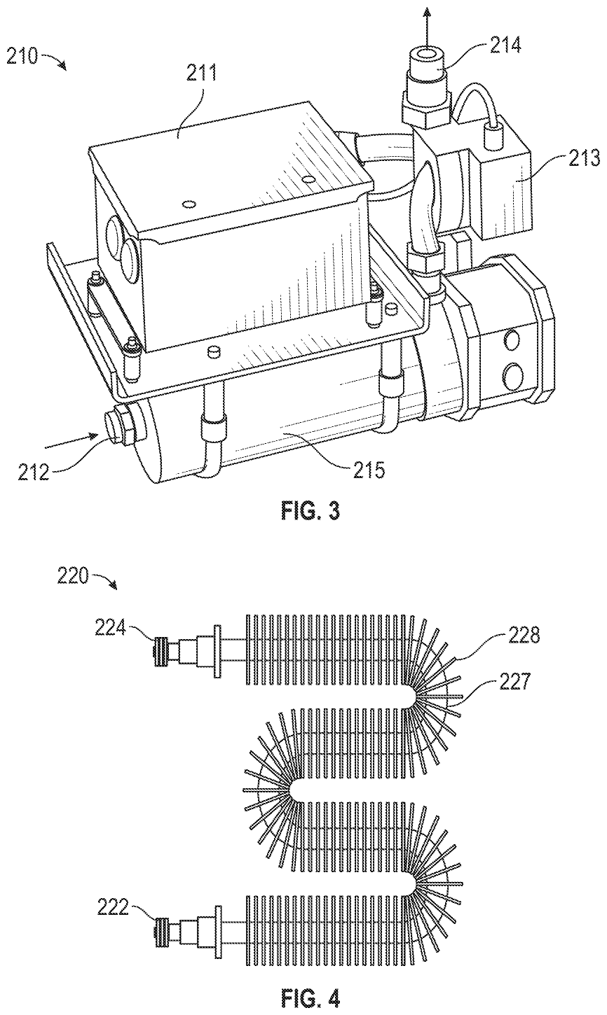

FIG. 3 is an perspective view of an exemplary heater. The heater 210 can comprise an electric, gasoline, or propane powered heater, or it can be powered by any other suitable fuel or power source that may be separate from the engine. For example, the heater 210 can be a commercially available electric jacket water heater that uses batteries. The heater 210 can further include a control system 211, a pump 213, and a tank 215. The tank 215 can include a heating element, a thermostat, and engine coolant. The engine coolant may comprise jacket water. The tank 215 may comprise die cast aluminum and a rubber insulating sleeve. The control system 211 can have a terminal strip and an contactor. The control system 211 can be operable to receive power from a power source, control the on/off state of the heating element located in the tank 215 by allowing or restricting power, control the heating element based on set a temperature point measured by the thermostat disposed in the tank 215, and control the on/off state of the pump 213 by allowing or restricting power. The control system 211 can be electrical communication with the engine and detect when the engine is started. The control system 211 can de-energize the heating element and pump 213 if the engine is started.

The heating element can be used to increase the temperature of nearby engine coolant via conduction. The thermostat can be disposed proximate to the heater inlet 212. The control system 211 can be operable to open and close a contactor that controls the heating element to be in the on or off state depending on the detected incoming engine coolant temperature from the thermostat. The pump 213 can be disposed proximate to the heater outlet 214. In other words, the pump 213 can be disposed between the heater inlet 212 and heater outlet 214. The pump 213 can be operable to pull the engine coolant through the heater 210. The pump 213 can force the flow and circulation of the engine's coolant through the engine block 170 via jacket water passages as part of the engine coolant circuit. The pump 213 can operate continuously independent of the thermostat and heating element.

The heater outlet 214 can be located proximate to top of the heater 210 and be in fluid communication with the pump 213. The heater inlet 212 can be located proximate to the bottom of the heater 210 and can be in fluid communication with the tank 215.

FIG. 4 is a plan view of an exemplary heat exchanger. The heat exchanger 220 can be operable to heat oil. The heat exchanger 220 can have its inlet 222 and outlet 224 disposed in a variety of orientations. The heat exchanger inlet 222 and heat exchanger outlet 224 can be disposed on the same side of the heat exchanger 220 and along the same plane. The heat exchanger inlet 222 can be disposed proximate the bottom of the heat exchanger 220 and the heat exchanger outlet 224 can be disposed proximate to the top of the heat exchanger 220. The heat exchanger 220 may include a fluid path 227 that extends from the heat exchanger inlet 222 to the heat exchanger outlet 224 and may be used for transporting the engine coolant and made of highly conductive material such as metal. The heat exchanger may include fins 228 made of highly conductive material that conducts heat from the fluid path 227 and that contains heated engine coolant. The fins 228 can radiate heat into the surrounding engine lubricant or oil. The heat exchanger 220 can comprise a shell and tube, plate, plate and shell, plate fin, pillow plate, or spiral heat exchanger.

### INDUSTRIAL APPLICABILITY

The present disclosure generally applies to heating engine coolant and engine lubrication for engines used in generators or quick start generators, machinery or equipment such as large trucks or tractors, or other machines and mechanisms requiring an engine running in cold environments. The disclosed heating system 200 can help prepare for and promote a successful start-up of an engine in cold environments with an engine heated coolant circuit. The engine is not needed to be on or started in order for circulation of the engine coolant.

Referring to FIG. 1 through FIG. 4, the pump 213 can circulate engine coolant from the heater 210 and heater outlet 214, through the heat exchanger 220, through jacket water passages in the engine block 170, and back to the heater inlet 212. The heater 210 can increase the temperature of an engine coolant with the heating element within the tank 215. The temperature of engine coolant coming from the engine block 170 and entering the heater inlet 212 can be measured by the thermostat and the heating element can be turned on or off depending on set temperature. The heated engine coolant can be circulated by the pump 213 from the heater outlet 214 through the first sealed port 162 on the oil pan 160, 161 and to the heat exchanger inlet 222 via the heater to heat exchanger fluid path 232. The heated coolant flows throughout the heat exchanger 220 from the heat exchanger inlet 222 to the heat exchanger outlet 224. The heat exchanger 220 transfers some of the energy/heat from the heated engine coolant to the surrounding engine lubricant, such as oil, as the heated engine coolant passes through. This increases the temperature of the engine lubricant through conduction and convection. The amount of external surface area of the heat exchanger 220 will drive the conduction efficiency and the location of the heat exchanger 220 in the oil pan 160, 161 will drive the convection efficiency. The engine coolant flows from the heat exchanger outlet 224 cooler than when it entered the heat exchanger inlet 222. The heated engine coolant decreases in temperature as it passes through the heat exchanger 220, but still maintains a higher temperature in comparison to the initial temperature of the engine coolant. The engine coolant flows through a second sealed port 164 on the oil pan 160, 161, and into the engine block inlet 172, such as a jacket water port. The first and second sealed ports 162, 164 can provide a sufficient seal around the heater to heat exchanger fluid path 232 and the heat exchanger to engine block fluid path 234 to prevent engine lubricant from leaking out of the oil pan 160, 161 and from air entering the oil pan 160, 161. The engine coolant flows from the heat exchanger 220 to the engine block 170 via the heat exchanger to engine block fluid path 234. The engine coolant can flow along jacket waters passages with in the engine block 170 to transfer heat the engine block 170. The flow of the engine coolant, the temperature of the engine coolant, and the jacket water passageway layout can be optimized through the engine block 170 to ensure uniform engine block heating is achieved. The engine coolant flow from the engine block 170 can be cooler than when it entered the engine block 170. The engine coolant flows out of the engine block 170 through the engine block outlet 174, such as a jacket water port. The engine coolant flows back to the heater 210 to and may be heated again.

Alternatively, the engine coolant may be pumped in the reverse direction and the engine coolant circuit can flow from the heater 210, to the engine block 170, to the heat exchanger 220, to the heater 210. The flow of the engine coolant circuit can be increased or decreased by selecting the appropriate pump 213 to match the heating requirements of the engine to be warmed up.

The control system 211 can be wired to or in signal communication with the engine and can shut off both the pump 213 and heating element if the engine is started. The control system 211 can also shut off the pump 213 and the heating element based on engine coolant temperature or engine temperature information received. For example, the heating system 200 can remain turned on and may start heating engine coolant and pumping engine coolant when engine coolant temperatures or engine temperatures decrease to a set temperature.

Generally, embodiments of the presently disclosed heating system 200 are applicable to the use, assembly, manufacture, operation, maintenance, repair, and improvement of engine heating systems 100, 101, and may be used in order to improve performance and efficiency, decrease maintenance and repair, and/or lower costs. In addition, the heating system 200 may be used in a first product, as a retrofit or enhancement to existing engines as a preventative measure, or even in response to an event.

Although this invention has been shown and described with respect to detailed embodiments and examples thereof, it will be understood by those skilled in the art that various changes in form and detail thereof may be made without departing from the spirit and scope of the claimed invention. Accordingly, the preceding detailed description is merely exemplary in nature and is not intended to limit the invention or the application and uses of the invention. In particular, the described embodiments are not limited to use in conjunction with a particular type of engine or engine heating system 100, 101. For example, the described embodiments may be applied to generators, engines, machinery, equipment, or any variant thereof. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

It will be understood that the benefits and advantages described above may relate to one embodiment or may relate to several embodiments. It is appreciated that features shown or discussed in one embodiment or example can be combined with other features shown or discussed in other embodiments and examples. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

What is claimed is:

1. A heating system for use with an engine , the engine having an oil pan and an engine block, the engine block having an engine block inlet and an engine block outlet, the heating system comprising:
a heater disposed outside of the engine block and the oil pan, in fluid communication with the engine block, having
a heater inlet, and
a heater outlet in fluid communication with the heater inlet;
a heat exchanger disposed within the oil pan and having
a heat exchanger inlet, and
a heat exchanger outlet in fluid communication with the heat exchanger inlet;
a heater to heat exchanger fluid path that extends from the heater outlet into the oil pan and to the heat exchanger inlet;
a heat exchanger to engine block fluid path extending from the heat exchanger outlet, through the oil pan, and to the engine block inlet; and
an engine block to heater fluid path extending from the engine block outlet to the heater inlet.

2. The heating system of claim 1 wherein the heater is an electric jacket water heater.

3. The heating system of claim 1, wherein the heat exchanger is centered in the oil pan.

4. The heating system of claim 3, wherein the heat exchanger is mounted to the oil pan.

5. The heating system of claim 1, wherein the heat exchanger is a plate fin exchanger.

6. The heating system of claim 1, the heater further comprises a pump disposed between the heater inlet and the heater outlet.

7. A heating system for use with an engine and an oil pan, the engine having an engine block, the engine block having an engine block inlet and an engine block outlet with a jacket water passages there between, the heating system comprising:
a heater disposed outside of the engine block and the oil pan, in fluid communication with the engine block, having
a heater inlet, and
a heater outlet in fluid communication with the heater inlet;
a heat exchanger disposed within the oil pan and having
a heat exchanger inlet, and
a heat exchanger outlet in fluid communication with the heat exchanger inlet; and
an engine coolant circuit for providing a path for engine coolant through the heater, heat exchanger, and the engine block passages.

8. The heating system of claim 7, the heater further comprises a pump disposed between the heater inlet and the heater outlet.

9. The heating system of claim 7 wherein the heater is an electric jacket water heater.

10. The heating system of claim 7, wherein the heat exchanger is centered in the oil pan.

11. The heating system of claim 10, wherein the heat exchanger is mounted to the oil pan.

12. The heating system of claim 7, wherein the heat exchanger is a plate fin exchanger.

13. An engine and a heating system for use in a machine, the engine and the heating system comprising:
an engine block having
a jacket water passage inlet, and
a jacket water passage outlet in fluid communication with the jacket water passage inlet;
an oil pan having
engine lubricant, and
a heat exchanger in fluid communication with the heater and the jacket water passage inlet;
a heater disposed outside of the engine block and oil pan in fluid communication with the jacket water passage outlet; and
engine coolant disposed with the oil pan, engine block, and heater.

14. The engine and the heating system of claim 13, the heater further comprises a pump disposed between the heater inlet and the heater outlet.

15. The engine and the heating system of claim 13, wherein the oil pan has a lower tier.

16. The engine with a heating system of claim 14, wherein the heat exchanger is disposed in the lower tier.

17. The engine and the heating system of claim 13, wherein the heat exchanger is centered in the oil pan.

18. The engine and the heating system of claim 13, wherein the heat exchanger is a plate fin heat exchanger.

19. The engine and the heating system of claim 13, wherein the engine coolant is jacket water.

20. The engine and the heating system of claim 13, wherein the engine lubricant is oil.
